(19) United States
(12) Patent Application Publication
(10) Pub. No.: US 2007/0132154 A1
(43) Pub. Date: Jun. 14, 2007

(54) LOW-TEMPERATURE HIGH-RATE SUPERPLASTIC FORMING OF CERAMIC COMPOSITE

(75) Inventors: Dustin M. Hulbert, Davis, CA (US); Joshua D. Kuntz, Livermore, CA (US); Amiya K. Mukherjee, Davis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: THE REGENTS OF THE UNIVERSITY OF CALIFORNIA, Oakland, CA (US)

(21) Appl. No.: 11/458,529

(22) Filed: Jul. 19, 2006

Related U.S. Application Data
(60) Provisional application No. 60/701,318, filed on Jul. 20, 2005.

(51) Int. Cl. H05B 6/00

(52) U.S. Cl. 264/434; 264/449; 264/642

(57) ABSTRACT

Ceramic materials are found to be capable of superplastic forming at moderate temperatures with a high strain rate when the forming is performed in the presence of an electric current such as that produced by spark plasma sintering.

### CROSS-REFERENCE TO RELATED APPLICATION

This application claims benefit from U.S. Provisional Patent Application No. 60/701,318, filed Jul. 20, 2005, the contents of which are incorporated herein by reference in their entirety.

### STATEMENT AS TO RIGHTS TO INVENTIONS MADE UNDER FEDERALLY SPONSORED RESEARCH OR DEVELOPMENT

This invention was made with Government support by Grant (or Contract) No. N00014-03-1-0148, awarded by the U.S. Office of Naval Research. The Government has certain rights in this invention.

### BACKGROUND OF THE INVENTION

This invention resides in the field of ceramic materials and articles manufactured from ceramic materials, and relates in particular to superplastic forming.

Superplasticity has been demonstrated in fine-grained polycrystalline ceramics such as YTZP (Wakai, F., et al., Ceram. Mater. 1:259 (1986)), magnesia-doped alumina (Morita, K., et al., J. Am. Ceram. Soc. 85(7): 1900-1902 (2002)), and alumina-reinforced YTZP (Zhou, X., et al., in J. P. Singh, ed., Advances in Ceramic Matrix Composites X, 165 (John Wiley & Sons, Inc., 2004)). Unfortunately, the temperatures at which superplastic forming was performed in these studies were typically above 1,450° C. and the strain rates were relatively low at 10⁻⁴ sec⁻¹ or lower. A high strain rate of 0.1 sec⁻¹ was reported by Kim, B.-N., et al., Nature 413: 288-291 (2001), but at a temperature of 1,650° C.

Spark plasma sintering of metals and metal compounds is also known in the art. One disclosure of the use of spark plasma sintering is a paper by Omori, N., Mater. Sci. & Eng. A287: 183-188 (2000). There is no suggestion of superplasticity in this paper, however, and no connection with the teachings of Wakai et al. and the other papers cited above.

The contents of all publications cited in this application are hereby incorporated by reference in their entirety.

### SUMMARY OF THE INVENTION

This invention resides in the discovery that ceramic materials can be readily formed by superplastic means into a variety of shapes by subjecting the materials to compression at moderate temperatures while exposing the materials to a sintering electric current, particularly under conditions known in the art as spark plasma sintering. By virtue of this discovery, ceramics can be formed using the same forming conditions as high-temperature alloys and superalloys. This discovery also permits the forming of metal-ceramic laminates in which the metal component is a high-temperature alloy or superalloy, in the same manner as the metals themselves and thus into virtually any shape, with both the metal and ceramic being formed simultaneously as part of the laminate. The invention is thus useful in the manufacture of armor plating for heavy-duty vehicles, equipment and clothing, as well as machine tools and other components of unusual shapes, all benefiting from the qualities of highly dense ceramics. This discovery also permits ceramics to be formed with the forming tools that are previously known for use only in forming high-temperature alloys and superalloys.

### BRIEF DESCRIPTION OF THE DRAWINGS

FIG. 1 is a cross sectional view of a sintering apparatus in which the superplastic forming process of the present invention can be performed, including a ceramic workpiece to be formed by the process.

FIG. 2 is a perspective view of the components of the sintering apparatus of FIG. 1 prior to application of the process.

FIG. 3 is the same view as FIG. 2 after superplastic forming has taken place.

### DETAILED DESCRIPTION OF THE INVENTION AND PREFERRED EMBODIMENTS

Ceramic materials that can be formed by superplastic means in accordance with this invention include ceramics in general, although preferred ceramics for use in this invention are metal oxides. Examples of metal oxide ceramics are alumina, magnesium oxide, zirconia, magnesia spinel, titania, calcium aluminate, cerium oxide, chromium oxide, and hafnium oxide. Further examples are combinations that include non-metal oxides such as silica. Still further examples are metallic oxides that also contain elements in addition to metals and oxygen, such as SiAlON and AlON. A metal oxide that is of particular interest is alumina, either in the form of α-alumina, γ-alumina, or a mixture of both. Another is an alumina-zirconia-magnesia spinel.

The ceramic prior to superplastic forming in accordance with this invention is preferably densified from a powder or from a green compact formed by compression of a powder. For the superplastic forming itself, the high strain rate that occurs during superplastic forming is most easily achieved in specimens with smaller grains. Thus, while the particle size of the ceramic powder can vary, the particles are preferably nano-sized. The term “nano-sized” refers to particles whose diameters are less than 100 nm, particularly 50 nm or below.

When a mixture of different ceramic materials is used, the mixture can be made uniform by thorough mixing, using any conventional means. One such means is by ball-milling the mixed powders in a conventional rotary mill with the assistance of tumbling balls. The sizes of the tumbling balls, the number of balls used per unit volume of powder, the rotation speed of the mill, the temperature at which the milling is performed, and the length of time that milling is continued can all vary widely. Best results will generally be achieved by wet milling, i.e., milling the particles while dispersed in a liquid such as ethanol, with a milling time ranging from about 4 hours to about 50 hours. The degree of mixing may also be affected by the “charge ratio,” which is the ratio of the mass of the balls to the mass of the powder. A charge ratio of from about 20 to about 100 will generally provide proper mixing.

The qualities of the compact and of the ultimate product formed by superplastic forming can be enhanced by mechanical activation of the ceramic particles prior to consolidating them into a compact. Mechanical activation is likewise achieved by methods known in the art and is typically performed in centrifugal or planetary mills that apply centrifugal and/or planetary action to the powder mixture with the assistance of milling balls. The milling balls, which may be the same as the tumbling balls cited above, produce impacts of up to 20 g (20 times the acceleration due to gravity). Variables such as the sizes of the milling balls, the number of milling balls used per unit amount of powder, the temperature at which the milling is performed, the length of time that milling is continued, and the energy level of the mill as determined by the rotational speed or the frequency of impacts, can vary widely. The number and size of the milling balls relative to the amount of powder is typically expressed as the “charge ratio,” which is defined as the ratio of the mass of the milling balls to the mass of the powder. A charge ratio of at least about 5, preferably about 5 to about 20, and most preferably about 10 to about 15, will generally provide the best results. Preferred milling frequencies are at least about 3, and preferably about 3 to 30 cycles per second or, assuming two impacts per cycle, at least about 6, and preferably about 6 to about 60 impacts per second.

Prior to superplastic forming, the ceramic powder is preferably first compressed into a green compact. Superplastic forming is then performed on the compact by applying a shear force to the compact while the compact is being compressed in the presence of a sintering electric field, preferably in uniaxial manner. Uniaxial compression can be achieved by conventional means. The benefits of the invention will be most evident when the composite is consolidated to a high density, i.e., one that approaches full theoretical density, which is the density of the material as determined by volume-averaging the densities of each of its components. The term “relative density” is used herein to denote the actual density expressed as a percent of the theoretical density. It is believed that favorable results will be achieved with a relative density of 90% or above, with best results at a relative density of at least 95%, preferably at least 98%, and most preferably at least 99%.

Sintering in the presence of an electric field, i.e., electric field-assisted sintering, in accordance with this invention is preferably performed by the process known as “spark plasma sintering.” One method of performing spark plasma sintering is by passing a pulsewise DC electric current through the dry powder mixture, or through the compact in cases where a compact is formed prior to sintering, while applying pressure. A description of spark plasma sintering and of apparatus in which this process can be performed is presented by Wang, S. W., et al., “Densification of Al₂O₃ powder using spark plasma sintering,” J. Mater. Res. 15(4), 982-987 (2000). While the conditions may vary, best results will generally be obtained with a densification pressure exceeding 10 MPa, preferably from about 10 MPa to about 200 MPa, and most preferably from about 40 MPa to about 100 MPa. The preferred current intensity is about 250 A/cm² to about 10,000 A/cm², most preferably about 500 A/cm² to about 1,500 A/cm². The duration of the pulsed current will generally range from about 1 minute to about 30 minutes, and preferably from about 1.5 minutes to about 5 minutes. During the sintering, the ceramic material preferably reaches a temperature within the range of about 800° C. to about 1,500° C., and most preferably about 900° C. to about 1,400° C. The compression and sintering are preferably performed under vacuum. Preferred vacuum levels for the densification are below 10 Torr, and most preferably below 1 Torr.

Superplastic forming in the practice of this invention is achieved by applying a shear strain to the ceramic material while the material is at a moderately elevated temperature as the electric current is passed through the material. The temperature for superplastic forming in accordance with this invention is about 1,400° C. or below, preferably about 1,300° C. or below, and most preferably about 1,200° C. or below. Preferred temperature ranges are from about 900° C. to about 1,400° C., and from about 1,100° C. to about 1,200° C. Further in the practice of this invention, superplastic forming can be achieved at strain rates of about 1×10⁻³ sec⁻¹ or higher, and preferably 5×10⁻² sec⁻¹ or higher. In terms of ranges, the strain rate is preferably from about 1×10⁻³ to about 1×10⁻¹ sec⁻¹. The duration of application of the shear strain at a superplastic forming condition is from about 30 seconds to about 10 minutes, preferably from about 1 minute to about 5 minutes. As is well known in the art, shear strain is achieved by deforming a solid body by displacing a plane parallel to itself relative to other planes in the body that are parallel to the plane being displaced. Shear strain is quantified as ratio of deformation perpendicular to a given line to the length of the line itself. Shear strains achieved in the practice of this invention are preferably in the range of about 0.3 to about 3.0, more preferably in the range of about 0.5 to about 1.5. Among those skilled in the art, strain rates are determined by the generalized Mukherjee-Bird-Dorn equation reported in Mukherjee, A. K., et al., Trans. Am. Soc. Metals 62:125-179 (1969), which is frequently used to describe the steady-state creep data. The equation is as follows:

$$\dot{ɛ} = A \frac{DGb}{kT} {( \frac{b}{d} )}^{p} {( \frac{σ}{G} )}^{n}$$

In this equation, \dot{ε} is the strain rate, A is a proportionality factor, D is the diffusion coefficient, G is the elastic shear modulus, b is the Burger's vector, k is the Boltzmann's constant, T is the absolute temperature, d is the grain size, p is the grain size dependence coefficient, σ is the applied stress, and n is the stress exponent. The inverse of the stress exponent n is the strain rate sensitivity m.

Grain boundary sliding is generally the predominant mode of deformation during superplastic flow. Superplastic deformation by grain-boundary sliding is typically characterized by n=2 (m=0.5) or higher and an activation energy that is equal to either the activation for lattice diffusion or the activation energy for grain-boundary diffusion.

The ability to achieve superplastic forming of ceramic materials at temperatures that are generally considered low for superplastic forming in accordance with this invention are particularly beneficial for nano-sized grains since the forming conditions allow the grains to remain nano-sized. Although this invention is not intended to be bound by any particular theory, it is believed that the nano size of the grains increases the ability of the material to be deformed by grain boundary sliding, the predominant mechanism associated with superplasticity, and that the solid-state diffusion of cations in the material is greatly enhanced through the electric field, as well as by the surface activation and electronic wind. The low temperatures and high strain rates associated with this advanced ceramic composite make the superplastic forming of ceramic parts industrially attractive.

### EXAMPLE

Nanocrystalline γ-Al₂O₃ powder with an average particle size of 15 nm obtained from Nanotechnologies, Inc. (Austin Tex., USA) was activated by high-energy ball milling (HEBM) with 1 weight percent polyvinyl alcohol for 24 hours in a Spex 8000 Mixer/Mill (Spex Industries, Metuchen, N.J., USA) in a tungsten carbide vial with a tungsten carbide milling ball. The activated powder was then heat treated in air at 350° C. to remove residual polyvinyl alcohol. To the activated alumina were then added nanocrystalline, partially stabilized tetragonal ZrO₂ containing 3 mole percent Y₂O₃ with an average particle size of 24 nm, obtained from Tosoh Corporation (Tokyo, Japan), and nanocrystalline cubic MgO of 40 nm particle size, obtained from NEI Corporation (Piscataway, N.J., USA). The resulting particle mixture was 3 parts alumina, 4 parts zirconia, and 3 parts magnesia spinel, by volume. The mixture was ball milled in an ethanol slurry in the Spex 8000 Mixer/Mill using zirconia ball media, then dried in air in a glass beaker on a hot plate and heated again at 350° C. for 3 hours to remove residual organics. The resulting powder mixture was then ground using a mortar and pestle, and sieved through a 150-μm mesh screen. The mixture was formed into green compacts in cylindrical graphite dies and punched using a pressure of 240 MPa at room temperature for approximately 5 minutes.

To densify the green compacts, each compact was sintered on a Dr. Sinter 1050 Spark Plasma Sintering System (Sumitomo Coal Mining Company, Japan) with a graphite die. Spark plasma sintering was then performed at an applied pressure of 50-70 MPa with a pulsed DC current of about 5,000 A maximum and a maximum voltage of 10 V. The pulses had a duration of about 10-14 ms with an interval between pulses of 1-4 ms. Once the pressure was applied, the samples were heated at a rate of 250-750° C./min to 1,050-1250° C. where they were held for 1-5 minutes. The temperature was monitored with an optical pyrometer focused on a depression in the graphite die or a thermocouple inserted in either the graphite die or in the punch. The green compact thus formed was a disk measuring 19 mm in diameter and 3 mm in thickness.

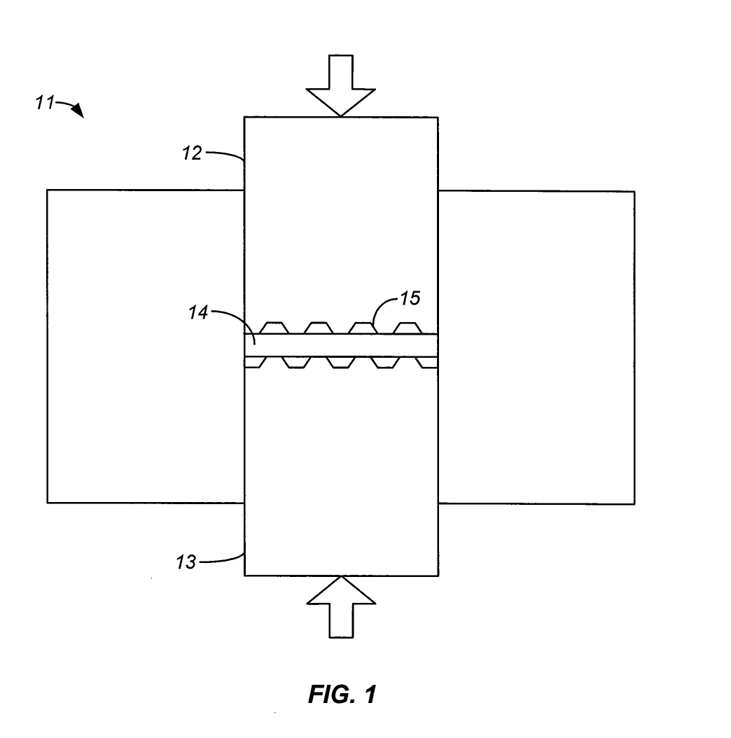

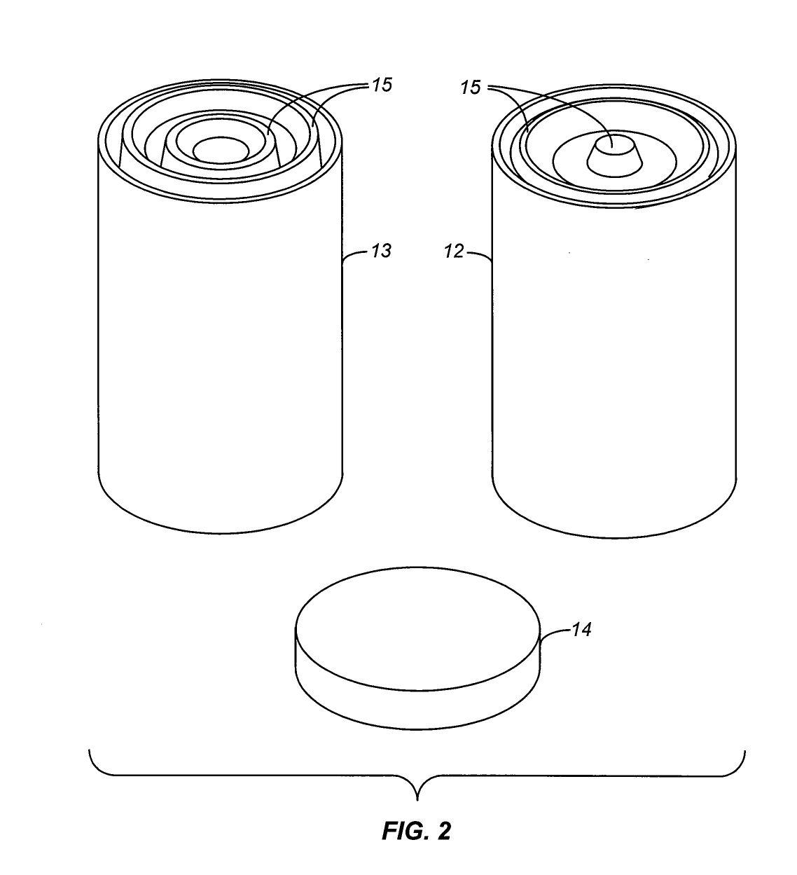

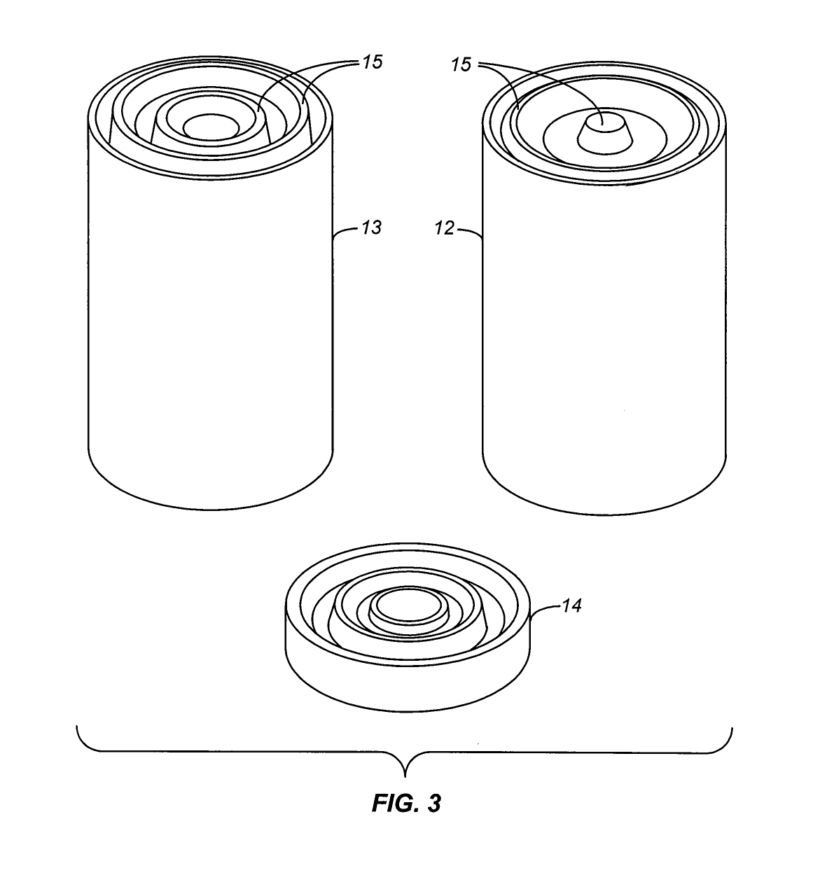

Once the disk was made fully dense by the above sintering process, superplastic forming was performed in the same spark plasma sintering equipment, using punches in the form of graphite cylinders measuring 19 mm in diameter and 21 mm in length, with contact surfaces of undulating contour forming circular protrusions, 1 mm in height, in the surfaces. The protrusions were in alternating positions between the two surfaces and thereby complementary to each other, with the sloping sides of each protrusion being at a 45° angle. FIG. 1 is a longitudinal cross section of the graphite die 11 and the punches 12, 13, showing the protrusions 15 in the punches. The disk 14 is shown in flat form between the punches, prior to superplastic forming. FIG. 2 is a perspective view of the punches 12, 13, showing the arrangement of the protrusions 15. The disk 14 is also shown prior to superplastic forming. Superplastic forming was achieved by heating the disk to 600° C. in 3 minutes and then to the superplastic forming temperature of 1,150° C. in 2 minutes at an applied pressure of 19 MPa. Once the disk had reached 1,150° C., the pressure was immediately increased to 78 MPa. Superplastic deformation took place during the increase in pressure from 19 MPa to 78 MPa. The result is shown in FIG. 3.

The final densities of the sintered compacts were measured by the Archimedes method using deionized water as the immersion medium. Microstructure determinations of the sintered compacts were performed with an FEI XL30-SFEG high-resolution scanning electron microscope (SEM) with a resolution better than 2 nm. Grain sizes were estimated from the SEM determinations on fracture surfaces. Mechanical compressive tests were performed at high temperature in air on an MTS 810 Material Test System (MTS Systems Inc., Eden Prairie, Minn., USA) controlled by a PC computer using LabView Software (National Instruments, Austin, Tex., USA) through an MTS 458.20 MicroConsole. High temperatures were obtained using an ATS 3320 furnace controlled by an ATS 2010 High Temperature Control System (Applied Test Systems, Inc., Butler, Pa., USA). Specimens were tested at temperatures ranging from 1,300° C. to 1,450° C. and at strain rates ranging from 10⁻⁴ sec⁻¹ to 10⁻¹ sec⁻¹. Specimens were cut into a bar shape measuring 3 mm×3 mm×5 mm and polished before testing. All tests were terminated once the specimens achieved a true strain rate \dot{ε}, per the Mukherjee-Bird-Dorn equation above, of approximately 0.5.

The microstructure of the alumina-zirconia-magnesia spinel composite consisted of equiaxed gains with an average diameter of approximately 100 nm. The compressive mechanical tests at high temperature, together with the strain rate as calculated from the Mukherjee-Bird-Dorn equation, indicated that the strain rate sensitivity m was 0.5, which is the inverse of the stress exponent n. The activation energy was determined to be 622 kJ/mol, which corresponds well to the activation energy associated with the superplastic deformation of yttria-stabilized tetragonal zirconia (YTZP) as reported by Wakai et al. above.

The alumina-zirconia-magnesia spinel as a green compact described above was in the form of a disk measuring 19 mm in diameter and 3 mm in thickness, and the punches in the spark plasma sintering apparatus were graphite cylinders measuring 19 mm in diameter and 21 mm in length, with contact surfaces of undulating contour forming circular protrusions, 1 mm in height, in the surfaces. The protrusions were in alternating positions between the two surfaces and thereby complementary to each other, with the sloping sides of each protrusion being at a 45° angle. FIG. 1 is a longitudinal cross section of the graphite die 11 and punches 12, 13, with the disk 14 (flat, prior to sintering) between them, and the protrusions 15 in the punches. FIG. 2 is a photograph of the punches 12, 13 and disk 14 prior to sintering, and FIG. 3 is a photograph of the same punches and disk after sintering at 1,150° C. for 3 minutes with the spark plasma sintering conditions set forth above. The calculated strain rate was approximately 1×10⁻² sec⁻¹. Due to the complementary contours of the punches, the disk experienced two types of compression, one where the disk was in contact with the flat areas on the punches, i.e., those at the tops of the raised portions and at the bottoms of the depressions, and the other where the disk was in contact with the sloping surfaces connecting the flat surfaces. The former was mainly pure compression, displaying only a slight deformation from the compression. This has been calculated to be approximately 6% engineering strain. The latter were exposed to large amounts of shear deformation, and calculation revealed that they were exposed to a shear strain of approximately 1. It was in this region that a strain rate of approximately 1×10⁻² sec⁻¹ was observed. Thus, the vast majority of the deformation in this specimen occurred in the form of a shearing strain.

The small equiaxed grains observed in the deformed structure indicate that the predominant mechanism of deformation resulting from the spark plasma sintering was superplasticity. By virtue of this superplastic forming, ceramics can be formed in accordance with this invention by the type of tooling that is known to be effective and useful in forming high-temperature superalloys and high-temperature alloys in general. The invention is of particular interest in forming metal-ceramic laminates by co-forming the metal and ceramic (i.e., simultaneously forming the metal and ceramic as laminae of a common laminate) and to thereby achieve enhanced mechanical and functional properties, notably the combination of high strength and toughness. When the ceramic-metal laminates are co-formed in this manner, the ceramic can serve as a thermal barrier material for the metal part.

What is claimed is:

1. A method for forming an article of ceramic material of a preselected shape, said method comprising deforming a compact of said ceramic material by shear deformation at a strain rate of about 10⁻³ sec⁻¹ or higher, while said compact is at a temperature of about 1,400° C. or below, and while an electric current is passed through said compact to achieve superplastic forming of said compact.

2. The method of claim 1 wherein said compact is a consolidated mass of particles whose diameters are less than 100 nm.

3. The method of claim 1 wherein said compact is a consolidated mass of particles whose diameters are less than 50 nm.

4. The method of claim 1 wherein said electric current is a pulsed DC current of from about 250 A/cm² to about 10,000 A/cm².

5. The method of claim 1 wherein said electric current is a pulsed DC current of from about 500 A/cm² to about 1,500 A/cm².

6. The method of claim 1 wherein said temperature is about 1,300° C. or lower.

7. The method of claim 1 wherein said temperature is about 1,200° C. or lower.

8. The method of claim 1 wherein said ceramic material is a metal oxide ceramic.

9. The method of claim 8 wherein said metal oxide ceramic is a member selected from the group consisting of alumina, magnesium oxide, zirconia, magnesia spinel, titania, calcium aluminate, cerium oxide, chromium oxide, and hafnium oxide.

10. The method of claim 8 wherein said metal oxide ceramic is a member selected from the group consisting of α-alumina, γ-alumina, and a mixture of α-alumina and γ-alumina.

11. The method of claim 1 wherein said metal oxide ceramic is an alumina-zirconia-magnesia spinel.

12. The method of claim 8 wherein said metal oxide ceramic comprises silica.

13. The method of claim 1 wherein said ceramic material comprises a member selected from the group consisting of SiAlON and AlON.

14. The method of claim 1 comprising deforming said compact by applying a shear strain at a strain rate of 10⁻³ sec⁻¹ or higher.

15. The method of claim 1 comprising deforming said compact by applying a shear strain at a strain rate of about 5×10⁻² sec⁻¹ or higher.

16. The method of claim 1 comprising deforming said compact by applying a shear strain for a duration of about 30 seconds to about 10 minutes.

17. The method of claim 1 comprising deforming said compact by applying a shear strain for a duration of about 1 minute to about 5 minutes.

18. A method for strengthening a laminate of metal and ceramic laminae by superplastic tooling, said method comprising deforming said laminate by shear deformation while said ceramic lamina is at an elevated temperature and while a electric current is passed through said ceramic lamina to achieve superplastic forming of said laminate.

19. The method of claim 18 wherein said compact is a consolidated mass of particles whose diameters are less than 50 nm, said electric current is a pulsed DC current of from about 500 A/cm² to about 1,500 A/cm², and said temperature is about 1,200° C. or lower.

20. The method of claim 18 comprising deforming said compact by applying a shear strain at a strain rate of about 5×10⁻² sec⁻¹ or higher, at a temperature of about 1,200° C. or lower for a duration of about 1 minute to about 5 minutes.
